(19) United States
(12) Patent Application Publication
(10) Pub. No.: US 2026/0163511 A1
(43) Pub. Date: Jun. 11, 2026

(54) DRIVE DEVICE

(71) Applicant: TOYOTA JIDOSHA KABUSHIKI KAISHA, Toyota-shi (JP)

(72) Inventor: Kazuhito HAYASHI, Toyota-shi (JP)

(73) Assignee: TOYOTA JIDOSHA KABUSHIKI KAISHA, Toyota-shi (JP)

(21) Appl. No.: 19/181,860

(22) Filed: Apr. 17, 2025

(30) Foreign Application Priority Data
Sep. 18, 2024 (JP) 2024-161437

(51) Int. Cl. H02P 27/08

(52) U.S. Cl. CPC H02P 27/08

(57) ABSTRACT

A drive device includes: a motor, an inverter that drives the motor; and a control device that controls the inverter by setting voltage commands of three phases based on a torque command for the motor and generating PWM signals of the three phases by comparing voltage command-related values of the three phases related to the voltage commands of the three-phases with a triangular wave. When the difference between the voltage command-related values of two phases out of the voltage command-related values of the three phases is equal to or less than a predetermined difference, the control device corrects the voltage command-related value such that either a timing at which the voltage command-related value of one of the two phases crosses the triangular wave or a timing at which the voltage command-related value of another of the two phases crosses the triangular wave, whichever is later, becomes even later.

### CROSS-REFERENCE TO RELATED APPLICATION

This application claims priority to Japanese Patent Application No. 2024-161437 filed on Sep. 18, 2024. The disclosure of the above-identified application, including the specification, drawings, and claims, is incorporated by reference herein in its entirety.

### BACKGROUND

### 1. Technical Field

The present disclosure relates to drive devices.

### 2. Description of Related Art

A drive device including a motor and an inverter has been proposed (see, for example, WO 2005/081389). The inverter drives the motor by switching a plurality of switching elements. In this drive device, a simultaneous switching preventing circuit is inserted between a three-phase pulse width modulation (PWM) signal generating circuit and a plurality of gate drive circuits. The three-phase PWM signal generating circuit generates three-phase control signals (PWM signals). Each of the gate drive circuits drives a corresponding one of the switching elements. The simultaneous switching preventing circuit includes a plurality of input units, a blocking pulse generating unit, a blocking signal forming unit, a signal blocking unit, and a plurality of output units. The input units receive three-phase control signals from the three-phase PWM signal generating circuit as input signals. The blocking pulse generating unit generates, in synchronization with a rise of the input signal of one phase, blocking pulses for blocking a rise of the input signals of the other phases during predetermined periods. The blocking signal forming unit outputs a blocking signal having a specific pulse width as a blocking period. The specific pulse width is the pulse width of a pulse formed by a logical disjunction of a plurality of blocking pulses from the blocking pulse generating units of the other phases. The signal blocking unit receives the input signal of one phase and outputs a signal whose rise is delayed until the end of the blocking period of the output signal from the blocking signal forming unit. The output units output the output signal from the signal blocking unit to the outside.

### SUMMARY

In the above drive device, the operation of the simultaneous switching preventing circuit reduces the possibility of simultaneous switching of multiple phases, and thus reduces the possibility of a relatively large surge voltage being applied to the motor. In the above drive device, the switching elements are not switched according to the three-phase control signals from the three-phase PWM signal generating circuit. Therefore, control of the motor may become unstable.

A primary object of a drive device of the present disclosure is to reduce the possibility of a relatively large surge voltage being applied to a motor while reducing the possibility of control of the motor becoming unstable.

The drive device of the present disclosure adopts the following measures to achieve the above primary object.

The drive device of the present disclosure is a drive device including:
a motor;
an inverter configured to drive the motor; and
a control device configured to control the inverter by setting voltage commands of three phases based on a torque command for the motor, and generating pulse width modulation signals of the three phases by comparing voltage command-related values of the three phases with a triangular wave. The voltage command-related values of the three phases are values related to the voltage commands of the three phases.
   The control device is configured to, when the difference between the voltage command-related values of two phases out of the voltage command-related values of the three phases is equal to or less than a predetermined difference, correct the voltage command-related value such that either the timing at which the voltage command-related value of one of the two phases crosses the triangular wave or the timing at which the voltage command-related value of another of the two phases crosses the triangular wave, whichever is later, becomes even later.

In the drive device of the present disclosure, the control device controls the inverter by setting voltage commands of the three phases based on a torque command for the motor, and generating pulse width modulation signals of the three phases by comparing voltage command-related values of the three phases related to the voltage commands of the three phases with a triangular wave. In this case, when the difference between the voltage command-related values of two phases out of the voltage command-related values of the three phases is equal to or less than the predetermined difference, the control device corrects the voltage command-related value such that either the timing at which the voltage command-related value of one of the two phases crosses the triangular wave or the timing at which the voltage command-related value of the other of the two phases crosses the triangular wave, whichever is later, becomes even later. Therefore, the inverter is controlled by correcting the voltage command-related value as described above without providing a simultaneous switching preventing circuit. This reduces the possibility of a relatively large surge voltage being applied to the motor while reducing the possibility of control of the motor becoming unstable.

In the drive device of the present disclosure (drive device described above), the control device may be configured to set, at the timing of a valley of the triangular wave, the voltage command-related values of the three phases for the timing of a following peak and later of the triangular wave, and when the difference is equal to or less than the predetermined difference, correct the voltage command-related value such that either the timing at which the voltage command-related value of one of the two phases crosses the triangular wave that is falling or the timing at which the voltage command-related value of the other of the two phases crosses the triangular wave that is falling, whichever is later, becomes even later.

In the drive device of the present disclosure (drive device described above), the control device may be configured to set, at the timing of a peak of the triangular wave, the voltage command-related values of the three phases for the timing of a following valley and later of the triangular wave, and when the difference is equal to or less than the predetermined difference, correct the voltage command-related value such that either the timing at which the voltage command-related value of one of the two phases crosses the triangular wave that is rising or the timing at which the voltage command-related value of the other of the two phases crosses the triangular wave that is rising, whichever is later, becomes even later.

In the drive device of the present disclosure (drive device described above), the control device may be configured to set duty cycle commands of the three phases based on the voltage commands of the three phases, and to generate the pulse width modulation signals of the three phases by comparing the duty cycle commands of the three phases with the triangular wave. The control device may be configured to, when the difference between the voltage commands of the two phases is equal to or less than the predetermined difference, correct the voltage command such that either the timing at which the duty cycle command of one of the two phases crosses the triangular wave or the timing at which the duty cycle command of the other of the two phases crosses the triangular wave, whichever is later, becomes even later.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 10 in which a drive device according to an embodiment is mounted;

FIG. 2 is a block diagram illustrating an example of functional blocks of control of the inverter 24;

FIG. 3 is a flow chart illustrating an example of a process routine; and

FIG. 4 illustrates an example of duty cycles Du*, Dv*, a triangular wave, and PWM signals Su*, Sv*.

### DETAILED DESCRIPTION OF EMBODIMENTS

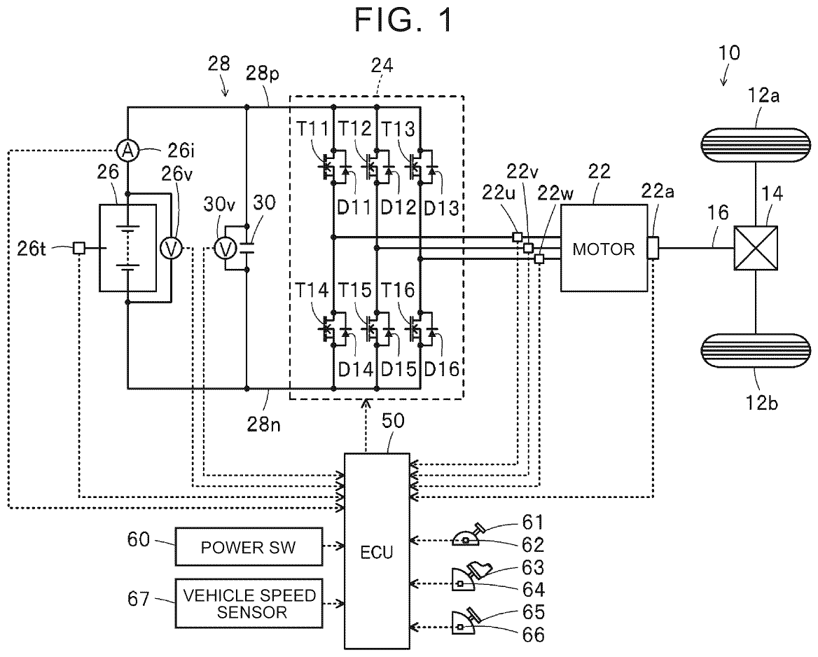

A mode for carrying out the present disclosure (embodiment) will be described with reference to the drawings. FIG. 1 is a schematic configuration diagram of a battery electric vehicle 10 in which a drive device according to the embodiment of the present disclosure is mounted. As illustrated, the battery electric vehicle 10 of the embodiment includes a motor 22, an inverter 24, a battery 26, and an electronic control unit (hereinafter referred to as “ECU”) 50.

The motor 22 is configured as a three-phase AC motor, and includes a rotor in which permanent magnets are embedded in the rotor core, and a stator in which three-phase (U-phase, V-phase, and W-phase) coils are wound around the stator core. The rotor of the motor 22 is connected to a drive shaft 16 connected to the drive wheel 12a, 12b via a differential gear 14.

The inverter 24 is connected to power line 28 (positive line 28p and negative line 28n) to which battery 26 is connected. The inverter 24 includes six transistors T11 to T16 as switching elements and six diodes D11 to D16 connected in parallel to each of the six transistors T11 to T16. The transistors T11 to T16 are arranged in pairs so as to be on the source-side and the sink-side with respect to the positive line 28p and the negative line 28n, respectively. Each of the connecting points of the two transistors that form the pair of the transistors T11 to T16 is connected to a three-phase (U-phase, V-phase, and W-phase) coil of the motor 22. Therefore, the ECU 50 adjusts the ratio of the on-time of each pair of transistors T11 to T16, and a rotating magnetic field is formed in the three-phase coil of the motor 22. As a result, the motor 22 (rotor) is driven to rotate. Hereinafter, the transistors T11, T14 are referred to as a “U-phase arm”, the transistors T12, T15 are referred to as a “V-phase arm”, and the transistors T13, T16 are referred to as a “W-phase arm”.

The battery 26 is configured as, for example, a lithium-ion secondary battery or a nickel-hydrogen secondary battery. The positive terminal and the negative terminal of the battery 26 are connected to the power line 28. A smoothing capacitor 30 is connected to the power line 28.

The ECU 50 includes a microcomputer having a CPU, a ROM, a RAM, a flash memory, input and output ports, and a communication port, various driving circuits, and various logic ICs. The ECU 50 receives signals from various sensors. For example, the rotational position θm of the rotor of the motor 22 from the rotational position sensor 22a and the phase currents Iu, Iv, Iw of each phase of the motor 22 from the current sensors 22u, 22v, 22w are inputted. The voltage Vb of the battery 26 from the voltage sensor 26v, the current Ib of the battery 26 from the current sensor 26i, the temperature Tb of the battery 26 from the temperature sensor 26t, and the voltage VH of the capacitor 30 (power line 28) from the voltage sensor 30v are also inputted. The ECU 50 also receives the following signals: an on-off signal from the power switch 60; an operating position of the shift lever 61 from the shift position sensor 62 (shift position SP); an amount of depression of the accelerator pedal 63 from the accelerator pedal position sensor 64 (accelerator operation amount Acc); an amount of depression of the brake pedal 65 from the brake pedal position sensor 66 (brake pedal position BP); and a vehicle speed V from the vehicle speed sensor 67. A switching control signal for the transistors T11 to T16 of the inverter 24 is output from the ECU 50. The ECU 50 calculates the electrical angle θe and the rotational speed Nm of the motor 22 based on the rotational position θm of the rotor of the motor 22, and calculates the power storage ratio SOC of the battery 26 based on the integrated value of the current Ib of the battery 26.

In battery electric vehicle 10 of the embodiment, the ECU 50 sets requested torque Td* (requested for the drive shaft 16) requested for traveling, based on the accelerator operation amount Acc and the vehicle speed V. The ECU 50 sets the torque command Tm* for the motor 22 so as to cause a vehicle to travel according to the set requested torque Td*. Then, the ECU 50 performs switching control of the transistors T11 to T16 of the inverter 24 based on the set torque command Tm*.

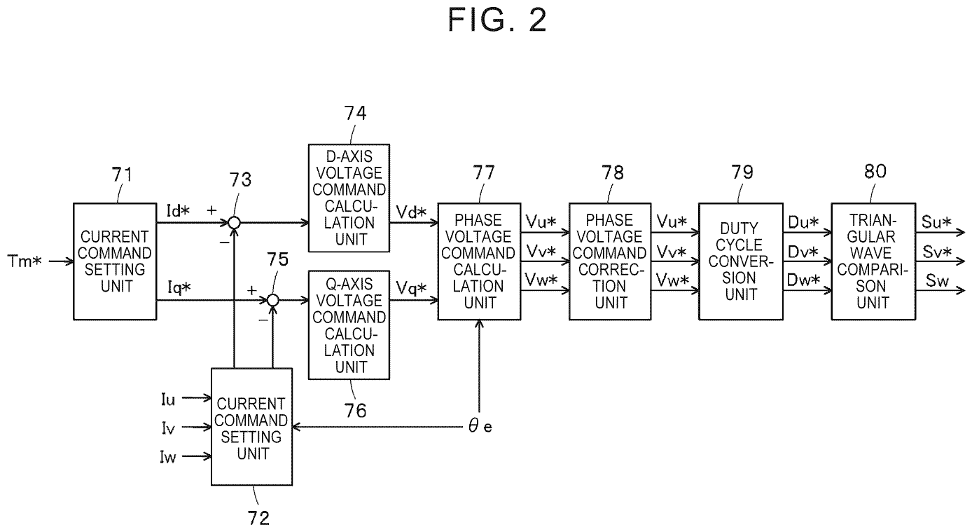

Here, the control of the inverter 24 by the ECU 50 will be described. FIG. 2 is a block diagram illustrating an example of functional blocks in the control of the inverter 24 by the ECU 50. As illustrated, the ECU 50 includes, as functional blocks, hardware such as CPU, in cooperation with a plurality of programs (software) installed in a ROM or a flash memory: a current command setting unit 71; a d-axis and q-axis current calculation unit 72; a subtraction unit 73; a d-axis voltage command calculation unit 74; a subtraction unit 75; a q-axis voltage command calculation unit 76; a phase voltage command calculation unit 77; a phase voltage command correction unit 78; a duty cycle conversion unit 79; a triangular wave comparison unit 80.

The current command setting unit 71 sets the d-axis and q-axis current commands Id*, Iq* of based on the torque command Tm*. The d-axis and q-axis current commands Id*, Iq* are set by, for example, deriving as follows. A map is defined as the relation between the torque command Tm* and the current commands Id*, Iq* by experimentation, analysis, or the like, and the torque command Tm* is applied to the map to derive the corresponding current commands Id*, Iq* from the map. The d-axis and q-axis current calculation unit 72 performs coordinate conversion (three-phase-two phase conversion) of the U-phase, V-phase, and W-phase phase currents Iu, Iv, Iw to the d-axis and q-axis currents Id, Iq using the electrical angle θe of the motor 22. The subtractor 73 subtracts the d-axis current Id from the d-axis current command Id*. The d-axis voltage command calculation unit 74 calculates the d-axis voltage command Vd* by current feedback control such that the d-axis current command Id* minus the d-axis current Id (Id*−Id) is canceled. The subtraction unit 75 subtracts the q-axis current Iq from the q-axis current command Iq*. The q-axis voltage command calculation unit 76 calculates the q-axis voltage command Vq* by current feedback control such that the q-axis current command Iq* minus the q-axis current Iq (Iq*−Iq) is canceled.

The phase voltage command calculation unit 77 performs coordinate conversion of the d-axis and q-axis voltage commands Vd*, Vq* to the U-phase, V-phase, and W-phase voltage commands Vu*, Vv*, Vw* using the electrical angle θe of the motor 22 (two-phase to three-phase conversion). The phase voltage command correction unit 78 corrects one of the U-phase, V-phase, and W-phase voltage commands Vu*, Vv*, Vw*, as needed. The duty cycle converter 79 divides the U-phase, V-phase, and W-phase voltage commands Vu*, Vv*, Vw* by the voltage VH of the capacitor 30 (power line 28) to calculate the U-phase, V-phase, and W-phase duty cycle commands Du*, Dv*, Dw*. The triangular wave comparison unit 80 generates the U-phase, V-phase, and W-phase PWM signals Su*, Sv*, Sw* by comparing the U-phase, V-phase, and W-phase duty cycle commands Du*, Dv*, Dw* with the triangular wave (carrier). When the U-phase, V-phase, and W-phase PWM signals Su*, Sv*, Sw* are generated in this manner, the transistors T11 to T16 is switched using this.

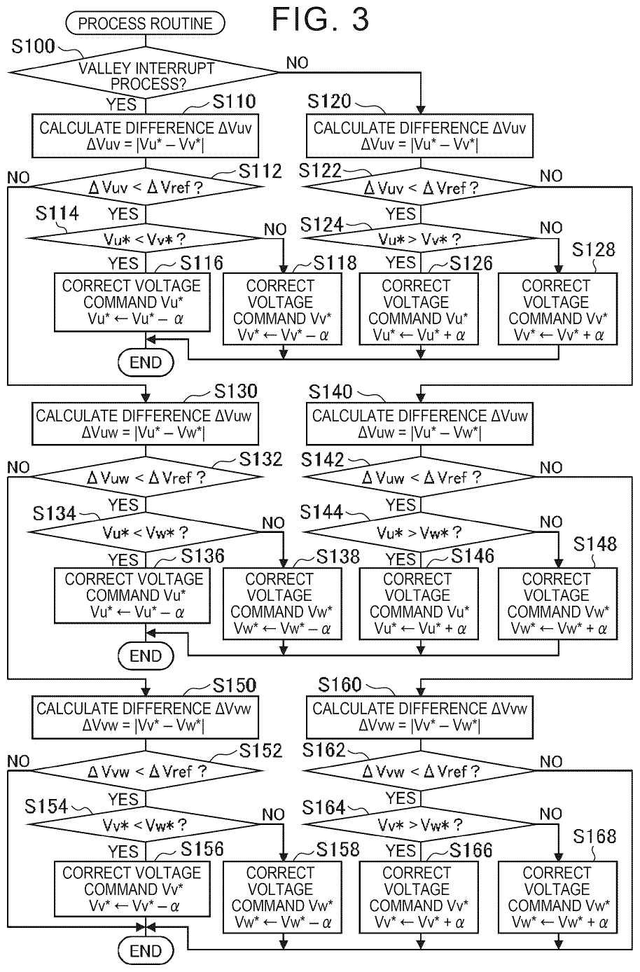

Here, the phase voltage command correction unit 78 will be described in detail. The phase voltage command correction unit 78 executes the process routine of FIG. 3. In the embodiment, the current command setting unit 71 to the phase voltage command calculation unit 77 perform, at the timing of a peak or a valley of the triangular wave, an interrupt process of setting the U-phase, V-phase, and W-phase voltage commands Vu*, Vv*, Vw* for the timing of the following valley or peak and later of the triangular wave (specifically, the timing of the following valley or peak to the timing of the subsequent peak or valley), and then the phase voltage command correction unit 78 executes the process routine of FIG. 3.

When the process routine of FIG. 3 is executed, the ECU 50 first determines whether the current interrupt process is an interrupt process at the timing of a valley of the triangular wave (hereinafter, referred to as “valley interrupt process”) or an interrupt process at the timing of a peak (hereinafter, referred to as “peak interrupt process”) (S100). When it is determined that the current interrupt process is a valley interrupt process, the difference ΔVuv is calculated as an absolute value of the value obtained by subtracting the V-phase voltage command Vv* from the U-phase voltage command Vu* from the phase voltage command calculation unit 77 (S110), and compares the calculated difference ΔVuv with the threshold ΔVref (S112). When PWM signals Su*, Sv*, Sw* of each phase are generated and the switching of each phase arm is performed, if the switching timings of the two-phase arms are relatively close to each other, a relatively large surge voltage may be applied to the motor 22. The threshold ΔVref is used to determine the presence or absence of such a concern.

When it is determined in S112 that the difference ΔVuv is less than the threshold ΔVref, it is determined that a relatively large surge voltage may be applied to the motor 22 because the switching timings of the U-phase and V-phase arms are relatively close to each other. Therefore, the U-phase and V-phase voltage commands Vu*, Vv* are compared with each other (S114). The voltage commands Vu*, Vv* are the values for the timing of the following peak of the triangular wave. Therefore, the U-phase and V-phase PWM signals Su*, Sv* are switched from off to on at the timings at which the U-phase and V-phase duty cycle commands Du*, Dv* based on the voltage commands Vu*, Vv* cross the falling triangular wave (hereinafter, referred to as “U-phase and V-phase falling crossing timings”, respectively), Therefore, the timing at which a smaller one of the duty cycle commands Du*, Dv* crosses the triangular wave is later than the timing at which a larger one of them crosses the triangular wave. Note that the magnitude relationship of the duty cycle command Du*, Dv* is the same as the magnitude relationship of the voltage command Vu*, Vv*, since the duty cycle command Du*, Dv* is obtained by dividing the voltage commands Vu*, Vv* by the voltage VH of the capacitor 30 (power line 28). The process of S114 is a process of determining which of the U-phase and V-phase falling cross timings is later.

When it is determined in S114 that the U-phase voltage command Vu* is less than the V-phase voltage command Vv*, it is determined that the U-phase falling cross timing is later than the V-phase falling cross timing. Then, the voltage command Vu* is corrected by setting the voltage command Vu* minus the predetermined value α to a new voltage command Vu* (S116), and the routine ends. On the other hand, when it is determined in S114 that the U-phase voltage command Vu* is equal to or higher than the V-phase voltage command Vv*, it is determined that the V-phase falling cross timing is later than the U-phase falling cross timing or both are the same. Then, the voltage command Vv* is corrected by setting the voltage command Vv* minus the predetermined value α to a new voltage command Vv* (S118), and the routine ends. The process of S116, S118 is a process of correcting one of the voltage commands Vu*, Vv* such that either the U-phase falling cross timing or the V-phase falling cross timing, whichever is later, becomes even later. The predetermined value α is determined based on the slope of the triangular wave etc. as a value that can reduce the possibility of a relatively large surge voltage being applied to the motor 22. With this process, the switching timings of the U-phase and V-phase arms are less likely to become relatively close, which reduces the possibility of a relatively large surge voltage being applied to the motor 22.

When it is determined in S112 that the difference ΔVuv is equal to or larger than the threshold ΔVref, the difference ΔVuw is calculated as an absolute value obtained by subtracting the W-phase voltage command Vw* from the U-phase voltage command Vu* from the phase voltage command calculation unit 77 (S130). Then, the calculated difference ΔVuw is compared with the threshold ΔVref (S132). When it is determined that the difference ΔVuw is less than the threshold ΔVref, the U-phase and W-phase voltage command Vu*, Vw* are compared with each other (S134). When it is determined that the U-phase voltage command Vu* is less than the W-phase voltage command Vw*, the voltage command Vu* is corrected by setting the voltage command Vu* minus the predetermined value α to a new voltage command Vu* (S136), and the routine ends. On the other hand, when it is determined that the U-phase voltage command Vu* is equal to or higher than the W-phase voltage command Vw*, the voltage command Vw* is corrected by setting the voltage command Vw* minus the predetermined value α to a new voltage command Vw* (S138), and this routine ends.

The process of S130 to S138 for the voltage commands Vu*, Vw* is the same as the process of S110 to S118 for the voltage commands Vu*, Vv*. That is, when the difference ΔVuw is less than the threshold value ΔVref, it is determined that there is a concern that the surge voltage applied to the motor 22 becomes relatively large because the switching timings of the U-phase and W-phase arms are relatively close to each other. Then, one of the voltage commands Vu*, Vw* is corrected such that either the timing at which the duty cycle command Du* based on the voltage command Vu* crosses the falling triangular wave and the timing at which the duty cycle command Dw* based on the voltage command Vw* crosses the falling triangular wave, whichever is later, becomes even later. With this process, the switching timings of the U-phase and W-phase arms are less likely to become relatively close, which reduces the possibility of a relatively large surge voltage being applied to the motor 22.

When it is determined in S132 that the difference ΔVuw is equal to or larger than the threshold ΔVref, the difference ΔVvw is calculated (S150) as an absolute value of a value obtained by subtracting the W-phase voltage command Vw* from the V-phase voltage command Vv* from the phase voltage command calculation unit 77. Then, the calculated difference ΔVvw is compared with the threshold ΔVref (S152). When it is determined that the difference ΔVvw is less than the threshold ΔVref, the V-phase and W-phase voltage commands Vv*, Vw* are compared with each other (S154). When it is determined that the V-phase voltage command Vv* is less than the W-phase voltage command Vw*, the voltage command Vv* is corrected by setting the voltage command Vv* minus the predetermined value α to a new voltage command Vv* (S156), and the routine ends. On the other hand, when it is determined that the V-phase voltage command Vv* is equal to or higher than the W-phase voltage command Vw*, the voltage command Vw* is corrected by setting the voltage command Vw* minus the predetermined value α to a new voltage command Vw* (S158), and this routine ends.

The process of S150 to S158 for the voltage commands Vv*, Vw* is the same as the process of S110 to S118 for the voltage commands Vu*, Vv*. That is, when the difference ΔVvw is less than the threshold value ΔVref, it is determined that there is a concern that the surge voltage applied to the motor 22 becomes relatively large because the switching timings of the V-phase and W-phase arms are relatively close to each other. Then, one of the voltage commands Vv*, Vw* is corrected such that either the timing at which the duty cycle command Dv* based on the voltage command Vv* crosses the falling triangular wave or the timing at which the duty cycle command Dw* based on the voltage command Vw* crosses the falling triangular wave, whichever is later, becomes even later. With this process, the switching timings of the V-phase and W-phase arms are less likely to become relatively close, and the surge voltage applied to the motor 22 is less likely to become relatively large. When it is determined in S152 that the difference ΔVvw is equal to or larger than the threshold ΔVref, the routine ends without correcting any of the U-phase, V-phase, and W-phase voltage commands Vu*, Vv*, Vw*.

When it is determined in S100 that the current interrupt process is a peak interrupt process, the difference ΔVuv as an absolute value of the value obtained by subtracting the V-phase voltage command Vv* from the U-phase voltage command Vu* from the phase voltage command calculation unit 77 (S120). Then, the calculated difference ΔVuv is compared with the threshold ΔVref (S122). The process of S122 is the same as the process of S112.

When it is determined in S122 that the difference ΔVuv is less than the threshold ΔVref, it is determined that the surge voltage applied to the motor 22 is relatively large because the switching timings of the U-phase and V-phase arms are relatively close to each other. Then, the U-phase and V-phase voltage commands Vu*, Vv* are compared with each other (S124). The voltage commands Vu*, Vv* are the values for the timing of the following valley of the triangular wave. Therefore, the U-phase and V-phase PWM signals Su*, Sv* are switched from on to off at the timings at which the U-phase and V-phase duty cycle command Du*, Dv* based on the voltage commands Vu*, Vv* cross the rising triangular wave, respectively (hereinafter referred to as “U-phase, V-phase rising cross timings,” respectively). Therefore, the timing at which a larger one of the duty cycle commands Du*, Dv* crosses the triangular wave becomes later than the timing at which a smaller one of the duty cycle commands Du*, Dv* crosses the triangular wave. The process of S124 is a process of determining which of the U-phase and V-phase rising cross timings is later.

When it is determined in S124 that the U-phase voltage command Vu* is larger than the V-phase voltage command Vv*, it is determined that the U-phase rising cross timing is later than the V-phase rising cross timing. Then, the voltage command Vu* is corrected by setting the voltage command Vu* plus the predetermined value α to a new voltage command Vu* (S126), and this routine ends. On the other hand, when it is determined in S124 that the U-phase voltage command Vu* is equal to or less than the V-phase voltage command Vv*, it is determined that the V-phase rising cross timing is later than the U-phase rising cross timing or both are the same. Then, the voltage command Vv* is corrected by setting the voltage command Vv* plus the predetermined value α to a new voltage command Vv* (S128), and this routine ends. The process of S126, S128 is a process of correcting one of the voltage commands Vu*, Vv* such that either the U-phase rising cross timing or the V-phase rising cross timing, whichever is later, becomes even later. By such processing, it is possible to suppress the switching timings of the U-phase and V-phase arms from becoming relatively close, and to suppress the surge voltage applied to the motor 22 from becoming relatively large.

When it is determined that the difference ΔVuv is equal to or larger than the threshold ΔVref in S122, the difference ΔVuw is calculated as the absolute value of the value obtained by subtracting the W-phase voltage command Vw* from the U-phase voltage command Vu* from the phase voltage command calculation unit 77 (S140). Then, the calculated difference ΔVuw is compared with the thresholds ΔVref (S142). When it is determined that the difference ΔVuw is less than the value ΔVref, the U-phase and W-phase voltage commands Vu*, Vw* are compared with each other (S144). When it is determined that the U-phase voltage command Vu* is larger than the W-phase voltage command Vw*, the voltage command Vu* is corrected by setting the voltage command Vu* plus the predetermined value α to a new voltage command Vu* (S146), and the routine ends. On the other hand, when it is determined that the U-phase voltage command Vu* is equal to or less than the W-phase voltage command Vw*, the voltage command Vw* is corrected by setting the voltage command Vw* plus the predetermined value α to a new voltage command Vw* (S148), and the routine ends.

The process of S140 to S148 for the voltage commands Vu*, Vw* is the same as the process of S120 to S128 for the voltage command Vu*, Vv*. That is, when the difference ΔVuw is less than the threshold value ΔVref, it is determined that there is a concern that a relatively large surge voltage may be applied to the motor 22 because the switching timings of the U-phase and W-phase arms are relatively close to each other. Then, one of the voltage commands Vu*, Vw* is corrected such that either the timing at which the duty cycle command Du* based on the voltage command Vu* crosses the rising triangular wave or the timing at which the duty cycle command Dw* based on the voltage command Vw* crosses the rising triangular wave, whichever is later, becomes even later. By such processing, it is possible to suppress the switching timings of the U-phase and W-phase arms from becoming relatively close, and to suppress the surge voltage applied to the motor 22 from becoming relatively large.

When it is determined that the difference ΔVuw is equal to or larger than the threshold ΔVref in S142, the difference ΔVvw is calculated as the absolute value of the value obtained by subtracting the W-phase voltage command Vw* from the V-phase voltage command Vv* from the phase voltage command calculation unit 77 (S160). Then, the calculated difference ΔVvw is compared with the thresholds ΔVref (S162). When it is determined that the difference ΔVvw is less than the value ΔVref, the V-phase and W-phase voltage commands Vv*, Vw* are compared with each other (S164). When it is determined that the V-phase voltage command Vv* is larger than the W-phase voltage command Vw*, the voltage command Vv* is corrected by setting the voltage command Vv* plus the predetermined value α to a new voltage command Vv* (S166), and the routine ends. On the other hand, when it is determined that the V-phase voltage command Vv* is equal to or less than the W-phase voltage command Vw*phase, the voltage commands Vw* is corrected by setting the voltage command Vw* plus the predetermined value α to a new voltage command Vw* (S168), and the routine ends.

The process of S160 to S168 for the voltage commands Vv*, Vw* is the same as the process of S120 to S128 for the voltage commands Vu*, Vv*. That is, when the difference ΔVvw is less than the threshold value ΔVref, it is determined that there is a concern that the surge voltage applied to the motor 22 becomes relatively large because the switching timings of the V-phase and W-phase arms are relatively close to each other. Then, one of the voltage commands Vv*, Vw* is corrected such that either the timing at which the duty cycle command Dv* based on the voltage command Vv* crosses the rising triangular wave or the timing at which the duty cycle command Dw* based on the voltage command Vw* crosses the rising triangular wave, whichever is later, becomes even later. By such processing, it is possible to suppress the switching timings of the V-phase and W-phase arms from becoming relatively close, and to suppress the surge voltage applied to the motor 22 from becoming relatively large. When it is determined in S162 that the difference ΔVvw is equal to or larger than the threshold ΔVref, the routine ends without correcting any of the U-phase, V-phase, and W-phase voltage commands Vu*, Vv*, Vw*.

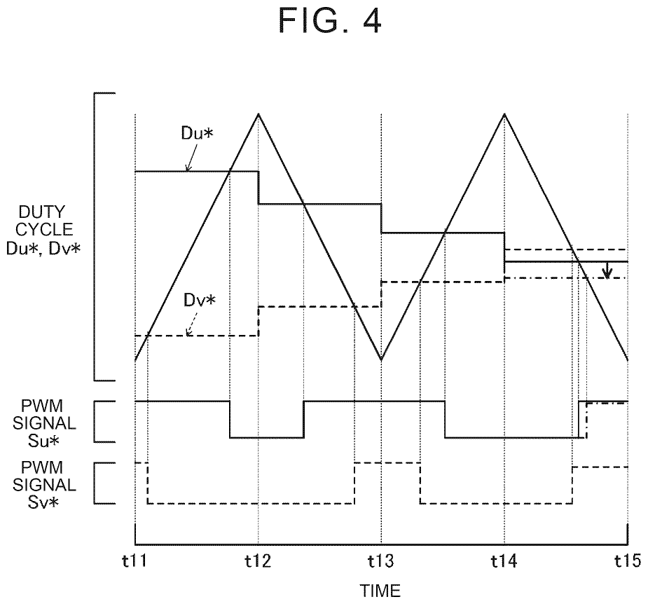

FIG. 4 is an explanatory diagram illustrating an exemplary state of the duty cycles Du*, Dv*, the triangular wave, and the PWM signals Su*, Sv*. In the drawing, times t11, t13, t15 are the timings of valleys of the triangular wave, and the valley interrupt process is performed at these times. Times t12, t14 are the timings of peaks of the triangular wave, and the peak interrupt process is performed at these times. The PWM signals Su*, Sv* are switched from on to off at the U-phase and V-phase rising cross timings, and the PWM signals Su*, Sv* are switched from off to on in the U-phase and V-phase falling cross timings. Note that the magnitude relationship between the duty cycle commands Du*, Dv* is the same as the magnitude relationship between the voltage commands Vu*, Vv*, because the duty cycle commands Du*, Dv* are obtained by dividing the voltage commands Vu*, Vv* by the voltage VH of the capacitor 30 (power line 28).

In the embodiment, at times t11, t12, t13, . . . , the voltage commands Vu*, Vv*, Vw* for times t12 to t13, t13 to t14, t14 to t15, . . . , are set as a valley interrupt process, a peak interrupt process, and a valley interrupt process, respectively. Then, in the valley interrupt process at time t13, it is determined that the difference ΔVuv is less than the threshold ΔVref, and it is determined that the voltage command Vu* is less than the voltage command Vv* (the duty cycle command Du* is less than the duty cycle command Dv*). That is, it is determined that the U-phase falling cross timing is later than the V-phase falling cross timing. Then, the voltage command Vu* is corrected by setting the voltage command Vu* minus the predetermined value α to a new voltage command Vu*. Thus, the duty cycle command Du* for time t14 to t15 is changed from the value corresponding to the voltage command Vu* before correction to the value corresponding to the voltage command Vv* after correction (change from a continuous line to a long dashed short dashed line in the figure). Correcting the voltage command Vu* (duty cycle command Du*) delays the timing of switching the PWM signal Su* from off to on (change from a continuous line to a long dashed short dashed line in the figure). Therefore, the switching timings of the U-phase and V-phase arms are less likely to become relatively close. As a result, it is possible to suppress the surge voltage applied to the motor 22 from becoming relatively large. Description of correction of one of the voltage commands Vu*, Vw* when the difference ΔVuw is less than the threshold ΔVref and correction of one of the voltage commands Vv*, Vw* when the difference ΔVvw is less than the threshold ΔVref is omitted.

In the drive device mounted on the battery electric vehicle 10 of the embodiment described above, when the difference ΔVuv between the voltage commands Vu*, Vv* is less than the threshold ΔVref, one of the voltage commands Vu*, Vv* is corrected. Specifically, one of the voltage commands Vu*, Vv* is corrected such that either the timing at which the duty cycle command Du* based on the voltage command Vu* crosses the triangular wave and the timing at which the duty cycle command Dv* based on the voltage commands Vv* crosses the triangular wave, whichever is later, becomes even later. Thus, it is possible to suppress the switching timing of the U-phase and V-phase arms from becoming relatively close, and to suppress the surge voltage applied to the motor 22 from becoming relatively large. The same applies when the difference ΔVuw of the voltage commands Vu*, Vw* is less than the threshold ΔVref or when the difference ΔVvw of the voltage commands Vv*, Vw* is less than the threshold ΔVref. In addition, one of the voltage commands Vu*, Vv*, Vw* is corrected without providing the simultaneous switching preventing circuit (adding a hardware configuration) as in WO 2005/081389 mentioned above. Accordingly, since the surge voltage applied to the motor 22 is suppressed from being relatively large, it is possible to prevent the control of the motor 22 from becoming unstable.

In the embodiment described above, the phase voltage command calculation unit 77 performs coordinate conversion of the d-axis and q-axis voltage commands Vd*, Vq* to the U-phase, V-phase, and W-phase voltage commands Vu*, Vv*, Vw* using the electrical angle θe of the motor 22. However, the present disclosure is not limited to this. For example, a predicted electrical angle θees, namely the sum of the electrical angle θe and the compensation amount Δθe, may be used instead of the electrical angle θe. The compensation amount Δθe is used to compensate for a deviation between the electrical angle θe used in the d-axis and q-axis current calculation unit 72 and the actual electrical angle when the phase voltage command calculation unit 77 performs the coordinate conversion, and is set so as to increase as the rotational speed Nm of the motor 32 increases.

In the above-described embodiment, the duty cycle converter 79 calculates the U-phase, V-phase, and W-phase duty cycle commands Du*, Dv*, Dw* by dividing the U-phase, V-phase, and W-phase voltage commands Vu*, Vv*, Vw* by the voltage VH of the capacitor 30 (power line 28). The triangular wave comparison unit 80 generates the U-phase, V-phase, and W-phase PWM signals Su*, Sv*, Sw* by comparing the U-phase, V-phase, and W-phase duty cycle commands Du*, Dv*, Dw* with a triangular wave. However, the present disclosure is not limited to this. For example, without including the duty cycle converter 79, the triangular wave comparison unit 80 may generate the U-phase, V-phase, and W-phase PWM signals Su*, Sv*, Sw* by comparing the U-phase, V-phase, and W-phase voltage commands Vu*, Vv*, Vw* with a triangular wave. In this case, the amplitude of the triangular wave may be set to the reference value multiplied by the voltage VH of the capacitor 30. When the difference ΔVuv between the voltage commands Vu*, Vv* is less than the threshold ΔVref, one of the voltage commands Vu*, Vv* may be corrected such that either the timing at which the voltage command Vu* crosses the triangular wave or the timing at which the voltage command Vv* crosses the triangular wave, whichever is later, becomes even later. The same applies when the difference ΔVuw between the voltage commands Vu*, Vw* is less than the threshold ΔVref or when the difference ΔVvw between the voltage commands Vv*, Vw* is less than the threshold ΔVref.

In the above embodiment, the interrupt process is performed at the timings of peaks and valleys of the triangular wave. However, the present disclosure is not limited to this. For example, the interrupt process may be performed only at the timings of either peaks or valleys of the triangular wave. When the interrupt process is performed only at the timings of valleys of the triangular wave, the current command setting unit 71 to the phase voltage command calculation unit 77 set the U-phase, V-phase, and W-phase voltage commands Vu*, Vv*, Vw* for the timings of the following and subsequent valleys of the triangular wave (specifically, the timing of the following valley to the timing of the subsequent valley). After that, the phase voltage command correction unit 78 may execute the process routine of FIG. 3, and determine in S100 that the current interrupt process is the valley interrupt process and performs S110 and the subsequent steps. When performing the interrupt process only at the timings of peaks of the triangular wave, the current command setting unit 71 to the phase voltage command calculation unit 77 set the U-phase, V-phase, and W-phase voltage commands Vu*, Vv*, Vw* for the timings of the following and subsequent peaks of the triangular wave (specifically, the timing of the following peak to the timing of the subsequent peak). After that, the phase voltage command correction unit 78 may execute the process routine of FIG. 3, and determine in S100 that the current interrupt process is a peak interrupt process and perform S120 and the subsequent steps.

In the above-described embodiment, the drive device mounted on battery electric vehicle 10 including the motor 22, the inverter 24, and the battery 26 is configured, but the present disclosure is not limited thereto. For example, in addition to the hardware configuration similar to that of battery electric vehicle 10, the drive device may be mounted on a hybrid electric vehicle that further includes an engine. In addition to the hardware configuration similar to battery electric vehicle 10, the drive device may be mounted on a fuel cell electric vehicle that further includes a fuel-cell.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to the manufacturing industry of drive devices etc.

What is claimed is:

1. A drive device comprising:
a motor;
an inverter configured to drive the motor; and
a control device configured to control the inverter by setting voltage commands of three phases based on a torque command for the motor, and generating pulse width modulation signals of the three phases by comparing voltage command-related values of the three phases with a triangular wave, the voltage command-related values of the three phases being values related to the voltage commands of the three phases,
wherein the control device is configured to, when a difference between the voltage command-related values of two phases out of the voltage command-related values of the three phases is equal to or less than a predetermined difference, correct the voltage command-related value such that either a timing at which the voltage command-related value of one of the two phases crosses the triangular wave or a timing at which the voltage command-related value of another of the two phases crosses the triangular wave, whichever is later, becomes even later.

2. The drive device according to claim 1, wherein the control device is configured to set, at a timing of a valley of the triangular wave, the voltage command-related values of the three phases for a timing of a following peak and later of the triangular wave, and when the difference is equal to or less than the predetermined difference, correct the voltage command-related value such that either a timing at which the voltage command-related value of one of the two phases crosses the triangular wave that is falling or a timing at which the voltage command-related value of the other of the two phases crosses the triangular wave that is falling, whichever is later, becomes even later.

3. The drive device according to claim 1, wherein the control device is configured to set, at a timing of a peak of the triangular wave, the voltage command-related values of the three phases for a timing of a following valley and later of the triangular wave, and when the difference is equal to or less than the predetermined difference, correct the voltage command-related value such that either a timing at which the voltage command-related value of one of the two phases crosses the triangular wave that is rising or a timing at which the voltage command-related value of the other of the two phases crosses the triangular wave that is rising, whichever is later, becomes even later.

4. The drive device according to claim 1, wherein:
the control device is configured to set duty cycle commands of the three phases based on the voltage commands of the three phases, and to generate the pulse width modulation signals of the three phases by comparing the duty cycle commands of the three phases with the triangular wave; and
the control device is configured to, when the difference between the voltage commands of the two phases is equal to or less than the predetermined difference, correct the voltage command such that either a timing at which the duty cycle command of one of the two phases crosses the triangular wave or a timing at which the duty cycle command of the other of the two phases crosses the triangular wave, whichever is later, becomes even later.
